(19) United States
(12) Patent Application Publication
(10) Pub. No.: US 2026/0251946 A1
(43) Pub. Date: Aug. 27, 2026

(54) FOLDABLE DISPLAY DEVICE

(71) Applicant: E Ink Holdings Inc., HSINCHU (TW)

(72) Inventors: Ya Han CHANG, HSINCHU (TW); Yi-Sheng LIN, HSINCHU (TW); Chia-Chun YEH, HSINCHU (TW); Chen-Chu TSAI, HSINCHU (TW)

(21) Appl. No.: 19/426,096

(22) Filed: Dec. 19, 2025

(30) Foreign Application Priority Data
Feb. 21, 2025 (TW) 114106595

(51) Int. Cl. G02F 1/167; G02F 1/1681; G02F 1/1675

(52) U.S. Cl. CPC G02F 1/167; G02F 1/1681; G02F 2001/1678

(57) ABSTRACT

A foldable display device includes a support structure, a lower stress adjustment structure, an upper stress adjustment structure, a cover layer sequentially disposed on the support structure, and a function display structure disposed between the lower stress adjustment structure and the upper stress adjustment structure. The total thickness of the support structure, the lower stress adjustment structure, the upper stress adjustment structure, the cover layer and the function display structure is not greater than 750 micrometers. The function display structure includes a driving layer, an electronic ink layer disposed on the driving layer, a transparent conductive water-resisting layer disposed on the electronic ink layer, and a sealant surrounding the electronic ink layer and connecting to the driving layer and the transparent conductive water-resisting layer. The thicknesses of the driving layer, the electronic ink layer, the transparent conductive water-resisting layer and the sealant are not greater than 60 micrometers, respectively.

This application claims priority to Taiwan Application Serial Number 114106595, filed February 21, 2025, which is herein incorporated by reference in its entirety.

### BACKGROUND

### Field of Invention

The present disclosure relates to a foldable display device.

### Description of Related Art

Recently, there has been an increasing demand for display devices that are compact and convenient with large-screen display capabilities. The use of a foldable display device provides the convenience of compactness and large-screen display capability. However, foldable display devices need to be folded or unfolded repeatedly, which tends to create strain in the various layers of the structure of the foldable display device, and excessive strain can cause damage or failure of the foldable display device.

### SUMMARY

At least one embodiment of the present disclosure provides a foldable display device that can reduce the strain of the foldable display device during folding by reducing the thickness and providing a stress adjustment structure, thereby enhancing the reliability.

The foldable display device according to at least one embodiment of the present disclosure includes a support structure, a lower stress adjustment structure, an upper stress adjustment structure, a cover layer and a function display structure. The lower stress adjustment structure is disposed on the support structure. The upper stress adjustment structure is disposed on the lower stress adjustment structure. The cover layer is disposed on the upper stress adjustment structure. The function display structure is disposed between the lower stress adjustment structure and the upper stress adjustment structure. The total thickness of the support structure, the lower stress adjustment structure, the upper stress adjustment structure, the cover layer and the function display structure is not greater than 750 micrometers. The function display structure includes a driving layer, an electronic ink layer, a transparent conductive water-resisting layer and a sealant. The electronic ink layer is disposed on the driving layer. The transparent conductive water-resisting layer is disposed on the electronic ink layer. The sealant surrounds the electronic ink layer and connects to the driving layer and the transparent conductive water-resisting layer. The thickness of the driving layer, the thickness of the electronic ink layer, the thickness of the transparent conductive water-resisting layer and the thickness of the sealant are not greater than 60 micrometers, respectively.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic top view of a foldable display device according to at least one embodiment of the present disclosure.

FIG. 2 is a schematic cross-sectional view taken along line a-a’ of FIG. 1.

FIG. 3 is a schematic cross-sectional view of a foldable display device according to at least another embodiment of the present disclosure.

FIG. 4 is a schematic cross-sectional view of a foldable display device according to at least another embodiment of the present disclosure.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

Furthermore, the words "about", "approximately" or "substantially" used in the present disclosure not only cover the clearly stated numerical values and numerical ranges, but also cover those that can be understood by a person with ordinary knowledge in the technical field to which the present disclosure belongs. The permissible deviation range can be determined by the error generated during measurement, and the error is caused, for example, by limitations of the measurement system or process conditions. For example, two objects (such as the plane or traces of a substrate) are "substantially parallel" or "substantially perpendicular," where "substantially parallel" and "substantially perpendicular," respectively, mean that parallelism and perpendicularity between the two objects can include non-parallelism and non-perpendicularity caused by permissible deviation ranges.

In addition, "about" may mean within one or more standard deviations of the above values, such as within ±30%, ±20%, ±10%, or ±5%. Such words as "about", "approximately", or "substantially" as appearing in the present disclosure may be used to select an acceptable range of deviation or standard deviation according to optical properties, etching properties, mechanical properties, or other properties, rather than applying all of the above optical properties, etching properties, mechanical properties, and other properties with a single standard deviation.

The spatial relative terms used in the present disclosure, such as "below," "under," "above," "on," and the like, are intended to facilitate the recitation of a relative relationship between one element or feature and another as depicted in the drawings. The true meaning of these spatial relative terms includes other orientations. For example, the relationship between one element and another may change from "below" and "under" to "above" and "on" when the drawing is turned 180 degrees up or down. In addition, spatially relative descriptions used in the present disclosure should be interpreted in the same manner.

Moreover, the present disclosure may be implemented or applied in various other specific embodiments, and the details of the present disclosure may be combined, modified, and altered in various embodiments based on different viewpoints and applications, without departing from the idea of the present disclosure.

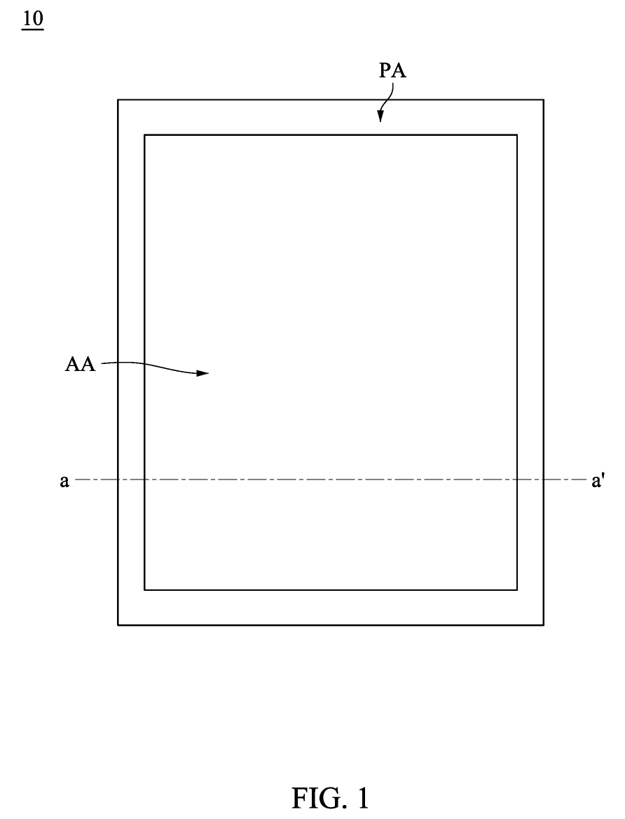

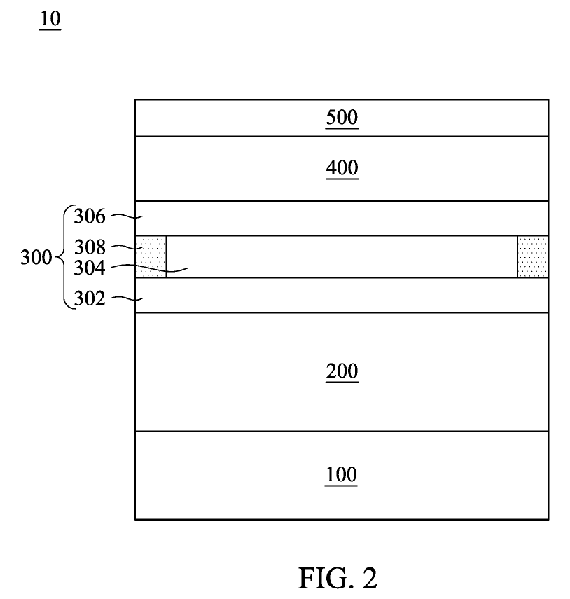

FIG. 1 is a schematic top view of a foldable display device 10 according to at least one embodiment of the present disclosure. FIG. 2 is a schematic cross-sectional view taken along line a-a’ of FIG. 1. Referring to FIG. 1 and FIG. 2, the foldable display device 10 has a display area AA and a peripheral area PA adjacent to the display area AA, and the foldable display device 10 includes a support structure 100, a lower stress adjustment structure 200, an upper stress adjustment structure 400, a cover layer 500 and a functional display structure 300.

The lower stress adjustment structure 200 is disposed on the support structure 100, the upper stress adjustment structure 400 is disposed on the lower stress adjustment structure 200, the cover layer 500 is disposed on the upper stress adjustment structure 400, and the function display structure 300 is disposed between the lower stress adjustment structure 200 and the upper stress adjustment structure 400. The total thickness of the support structure 100, the lower stress adjustment structure 200, the upper stress adjustment structure 400, the cover layer 500, and the function display structure 300 is approximately not greater than 750 micrometers.

The function display structure 300 includes a driving layer 302, an electronic ink layer 304, a transparent conductive water-resisting layer 306, and a sealant 308. The electronic ink layer 304 is disposed on the driving layer 302, the transparent conductive water-resisting layer 306 is disposed on the electronic ink layer 304, and the sealant 308 surrounds the electronic ink layer 304 and connects to the driving layer 302 and the transparent conductive water-resisting layer 306. The thickness of the driving layer 302, the thickness of the electronic ink layer 304, the thickness of the transparent conductive water-resisting layer 306, and the thickness of the sealant 308 are approximately not greater than 60 micrometers, respectively.

The total thickness of the foldable display device 10 can be effectively reduced by disposing the transparent conductive water-resisting layer 306 with multifunction, and as the total thicknesses of the various structures of the foldable display device 10 is approximately not greater than 750 micrometers, the thicknesses of the various layers of the function display structure 300 are approximately not greater than 60 micrometers, and the lower stress adjustment structure 200 and the upper stress adjustment structure 400 are provided, the strain in the foldable display device 10 during folding is reduced, thereby enhancing the reliability.

In some embodiments, the transparent conductive water-resisting layer 306 may include a substrate formed of transparent flexible polymer, and a film layer formed of a transparent conductive material and a water-resisting material which is disposed on the surface of the aforementioned substrate. The transparent conductive water-resisting layer 306 has light-transmitting properties, conductive and water-resisting functions. The material of the transparent conductive water-resisting layer 306 may include indium tin oxide and polymethyl methacrylate, polyimide, polyethylene terephthalate, polyurethane or polycarbonate. The Young's modulus of the sealant 308 is approximately not greater than 1 GPa. The sealant 308 may be, for example, a polymer glue or an adhesive tape, and the sealant 308 is disposed in the peripheral area PA of the foldable display device 10. In addition, the total thickness of the driving layer 302, the electronic ink layer 304 and the transparent conductive water-resisting layer 306 may be approximately not greater than 90 micrometers.

In some embodiments, the driving layer 302 may be a film layer formed of metal and flexible polymer. The driving layer 302 may include, for example, switching elements (not shown, such as transistors) or other electronic elements (not shown, such as capacitors). The electronic ink layer 304 may include a microcup electrophoretic display medium or a microcapsule electrophoretic display medium, and the aforementioned electrophoretic display medium may include an electrophoretic liquid and multiple colored particles distributed in the electrophoretic liquid, but the present invention is not limited thereto. The thickness of the cover layer 500 is approximately not greater than 110 micrometers. The material of the cover layer 500 includes polymethyl methacrylate, polyimide, polyethylene terephthalate, polyurethane or polycarbonate.

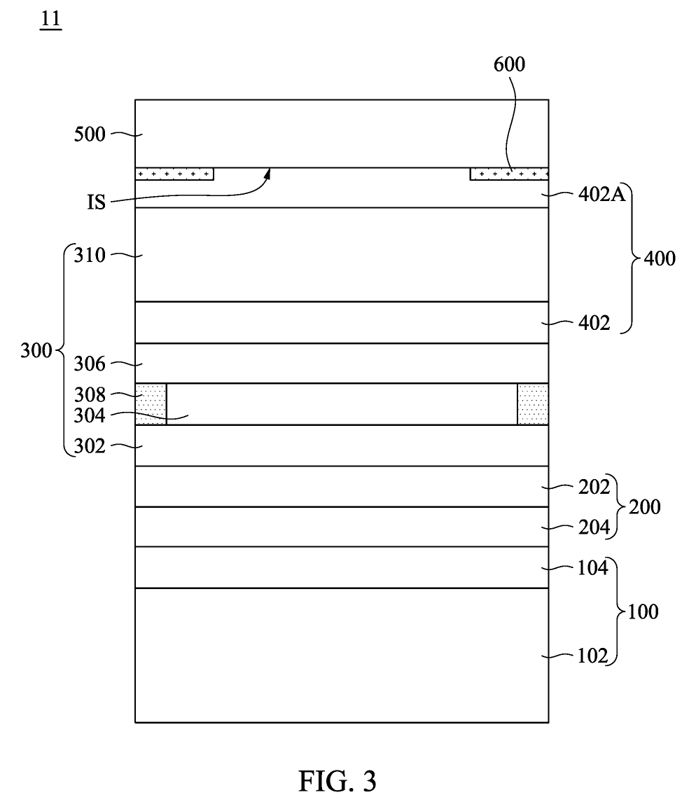

FIG. 3 is a schematic cross-sectional view of a foldable display device 11 according to at least another embodiment of the present disclosure. Referring to FIG. 3, the structures, the materials and the relative positions of most elements in the embodiment of FIG. 3 and the embodiment of FIG. 2 are the same, and the schematic top view of the foldable display device 11 in FIG. 3 is substantially the same as the schematic top view of the foldable display device 10 in FIG. 2, so the same features are not repeated here. The main difference between the embodiment of FIG. 3 and the embodiment of FIG. 2 is that the foldable display device 11 further includes a decorative pattern 600, the support structure 100 of the foldable display device 11 includes a support layer 102 and a connection layer 104, the lower stress adjustment structure 200 of the foldable display device 11 includes a lower adhesive layer 202 and a lower film layer 204, the function display structure 300 of the foldable display device 11 includes a functional layer 310, and the upper stress adjustment structure 400 of the foldable display device 11 includes upper adhesive layers 402, 402A.

As shown in FIG. 3, the connection layer 104 is disposed on the support layer 102, the lower adhesive layer 202 is in contact with the driving layer 302, and the lower film layer 204 is in contact with the connection layer 104. The functional layer 310 and the upper adhesive layers 402, 402A are arranged alternately, the upper adhesive layer 402 is in contact with the transparent conductive water-resisting layer 306, and the upper adhesive layer 402A is in contact with the cover layer 500. The cover layer 500 has an inner surface IS facing the upper stress adjustment structure 400, the decorative pattern 600 is disposed on the inner surface IS, and the decorative pattern 600 is disposed in the peripheral area PA of the foldable display device 11 and overlaps the sealant 308.

In some embodiments, the shear modulus of the upper adhesive layers 402, 402A are smaller than the shear modulus of the lower adhesive layer 202, respectively. The thicknesses of the upper adhesive layers 402, 402A are approximately not greater than 60 micrometers, and the shear modulus of the upper adhesive layers 402, 402A are approximately not greater than 60 kPa, respectively. The upper adhesive layer 402, 402A may be, for example, optical clear adhesive. The thickness of the lower adhesive layer 202 is approximately not greater than 60 micrometers, the shear modulus of the lower adhesive layer 202 at about 20 degrees to 40 degrees Celsius is approximately greater than 100 kPa, and the shear modulus of the lower adhesive layer 202 at a temperature about not greater than 0 degrees Celsius is approximately smaller than 2 MPa. The lower adhesive layer 202 may be, for example, a pressure sensitive adhesive. The thickness of the lower film layer 204 is approximately not greater than 160 micrometers. The lower film layer 204 may be, for example, a film layer formed of flexible polymer. The material of the lower film layer 204 may include polymethyl methacrylate, polyimide, polyethylene terephthalate, polyurethane or polycarbonate.

Through the stacking design of the lower adhesive layer 202, the lower film layer 204, the upper adhesive layers 402, 402A and the function display structure 300, and the design of the thicknesses and the shear modulus of the lower adhesive layer 202 and the upper adhesive layers 402, 402A, the strain values of the functional layer 310 and the driving layer 302 are about 1.28% and 0.08%, respectively, to achieve the effect of a multi-neutral axis with the strain values of the multiple layers being close to 0. In particular, the strain value of the driving layer 302 being about 0.08% prevents the driving layer 302 from line crack, and can pass the low and high temperature bending test. Therefore, the strain in the foldable display device 11 during folding can be effectively reduced, thereby enhancing the reliability.

In some embodiments, the thickness of the functional layer 310 is approximately not greater than 160 micrometers, the functional layer 310 may be, for example, a touch control functional layer or an optical functional layer with a substrate formed of transparent flexible polymer, which may include polymethyl methacrylate, polyimide, polyethylene terephthalate, polyurethane or polycarbonate. The total thickness of the driving layer 302, the electronic ink layer 304, the transparent conductive water-resisting layer 306, and the functional layer 310 may be approximately not greater than 190 micrometers. The thickness of the support layer 102 may be approximately no greater than 300 micrometers, and the material of the support layer 102 may include metal or polymer. The material of the connection layer 104 may include a polymer glue or an adhesive tape. The material of the decorative pattern 600 may include ink.

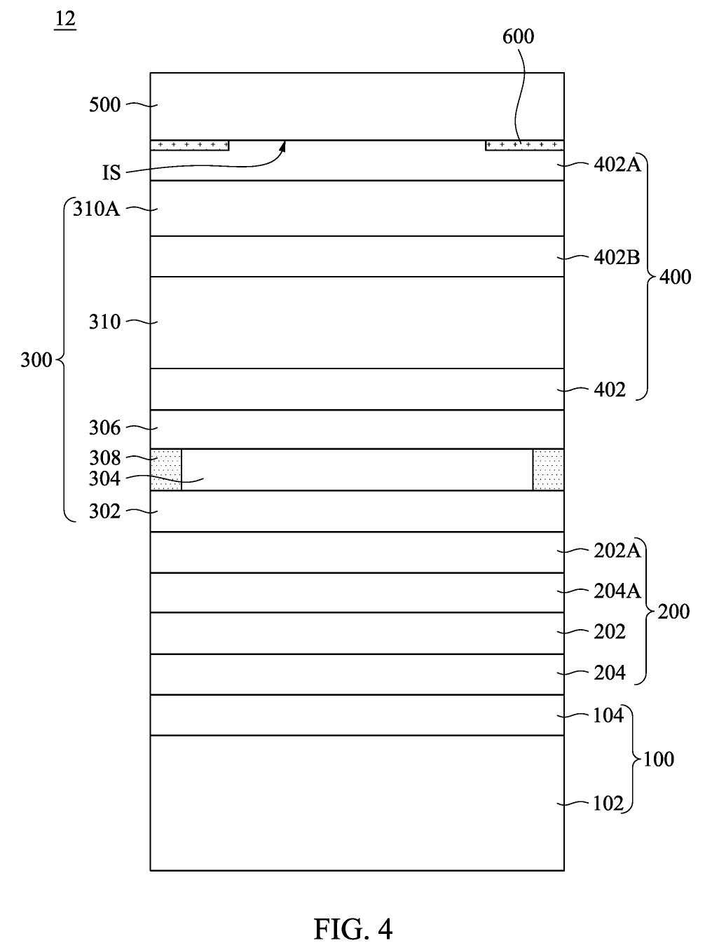

FIG. 4 is a schematic cross-sectional view of a foldable display device 12 according to at least another embodiment of the present disclosure. Referring to FIG. 4, the structures, the materials and the relative positions of most elements in the embodiment of FIG. 4 and the embodiment of FIG. 3 are the same, and the schematic top view of the foldable display device 12 in FIG. 4 is substantially the same as the schematic top view of the foldable display device 10 in FIG. 2, so the same features are not repeated here. The main difference between the embodiment of FIG. 4 and the embodiment of FIG. 3 is that the lower stress adjustment structure 200 of the foldable display device 12 further includes a lower adhesive layer 202A and a lower film layer 204A, the function display structure 300 of the foldable display device 12 further includes a function layer 310A, and the upper stress adjustment structure 400 of the foldable display device 12 further includes an upper adhesive layer 402B.

As shown in FIG. 4, the lower adhesive layers 202, 202A and the lower film layers 204, 204A are arranged alternately, one of the lower adhesive layers 202, 202A (e.g., the lower adhesive layer 202A) is in contact with the driving layer 302, and one of the lower film layers 204, 204A (e.g., the lower film layer 204) is in contact with the connection layer 104. The functional layers 310, 310A and the upper adhesive layers 402, 402A, 402B are arranged alternately, and two of the upper adhesive layers 402, 402A, 402B (e.g., the upper adhesive layers 402, 402A) are in contact with the transparent conductive water-resisting layer 306 and the cover layer 500, respectively.

In some embodiments, the functional layer 310 may be, for example, one of a touch control functional layer and an optical functional layer, and the functional layer 310A may be the other of the aforementioned touch control functional layer and the aforementioned optical functional layer, but the present invention is not limited thereto. The thickness, shear modulus, and material of the upper adhesive layer 402B may be the same as the upper adhesive layers 402, 402A, the thickness, shear modulus, and material of the lower adhesive layer 202A may the same as the lower adhesive layer 202, and the thickness and material of the lower film layer 204A may the same as the lower film layer 204.

In summary, in at least one embodiment of the foldable display device of the present disclosure, the total thickness of the foldable display device can be effectively reduced by disposing the transparent conductive water-resisting layer with multifunction, and as the total thicknesses of the various structures of the foldable display device is approximately not greater than 750 micrometers, the thicknesses of the various layers of the function display structure are approximately not greater than 60 micrometers, and the lower stress adjustment structure and the upper stress adjustment structure are provided, the strain in the foldable display device during folding is reduced, thereby enhancing the reliability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A foldable display device, comprising:
a support structure;
a lower stress adjustment structure, disposed on the support structure;
an upper stress adjustment structure, disposed on the lower stress adjustment structure;
a cover layer, disposed on the upper stress adjustment structure; and
a function display structure, disposed between the lower stress adjustment structure and the upper stress adjustment structure, wherein a total thickness of the support structure, the lower stress adjustment structure, the upper stress adjustment structure, the cover layer and the function display structure is not greater than 750 micrometers, and the function display structure comprises:
a driving layer;
an electronic ink layer, disposed on the driving layer;
a transparent conductive water-resisting layer, disposed on the electronic ink layer; and
a sealant, surrounding the electronic ink layer and connecting to the driving layer and the transparent conductive water-resisting layer, wherein a thickness of the driving layer, a thickness of the electronic ink layer, a thickness of the transparent conductive water-resisting layer and a thickness of the sealant are not greater than 60 micrometers, respectively.

2. The foldable display device of claim 1, wherein a material of the transparent conductive water-resisting layer comprises indium tin oxide and polymethyl methacrylate, polyimide, polyethylene terephthalate, polyurethane or polycarbonate.

3. The foldable display device of claim 1, wherein a Young's modulus of the sealant is not greater than 1 GPa.

4. The foldable display device of claim 1, wherein the upper stress adjustment structure comprises one or multiple upper adhesive layers, and the lower stress adjustment structure comprises one or multiple lower adhesive layers, wherein a shear modulus of each of the upper adhesive layers is smaller than a shear modulus of each of the lower adhesive layers.

5. The foldable display device of claim 4, wherein a thickness of each of the upper adhesive layers is not greater than 60 micrometers, and the shear modulus of each of the upper adhesive layers is not greater than 60 kPa.

6. The foldable display device of claim 5, wherein each of the upper adhesive layers is an optical clear adhesive.

7. The foldable display device of claim 5, wherein the functional display structure comprises one or multiple functional layers, a thickness of each of the functional layers is not greater than 160 micrometers, and the functional layers and the upper adhesive layers are arranged alternately.

8. The foldable display device of claim 5, wherein two of the upper adhesive layers are in contact with the transparent conductive water-resisting layer and the cover layer, respectively.

9. The foldable display device of claim 4, wherein the lower stress adjustment structure comprises one or multiple lower film layers, a thickness of each of the lower film layers is not greater than 160 micrometers, and the lower adhesive layers and the lower film layers are arranged alternately, wherein a thickness of each of the lower adhesive layers is not greater than 60 micrometers, the shear modulus of each of the lower adhesive layers at 20 to 40 degrees Celsius is greater than 100 kPa, and the shear modulus of each of the lower adhesive layers at a temperature not greater than 0 degrees Celsius is smaller than 2 MPa.

10. The foldable display device of claim 9, wherein each of the lower adhesive layers is a pressure sensitive adhesive.

11. The foldable display device of claim 9, wherein a material of each of the lower film layers comprises polymethyl methacrylate, polyimide, polyethylene terephthalate, polyurethane or polycarbonate.

12. The foldable display device of claim 9, wherein the support structure comprises:
a support layer, wherein a thickness of the support layer is not greater than 300 micrometers, and a material of the support layer comprises metal or polymer; and
a connection layer, disposed on the support layer.

13. The foldable display device of claim 12, wherein one of the lower adhesive layers is in contact with the driving layer, and one of the lower film layers is in contact with the connection layer.

14. The foldable display device of claim 1, wherein a thickness of the cover layer is not greater than 110 micrometers, and a material of the cover layer comprises polymethyl methacrylate, polyimide, polyethylene terephthalate, polyurethane or polycarbonate.

15. The foldable display device of claim 1, further comprises:
a decorative pattern, wherein the cover layer has an inner surface facing the upper stress adjustment structure, and the decorative pattern is disposed on the inner surface.

16. The foldable display device of claim 1, wherein the electronic ink layer comprises a microcup electrophoretic display medium or a microcapsule electrophoretic display medium.

17. The foldable display device of claim 16, wherein the microcup electrophoretic display medium or the microcapsule electrophoretic display medium comprises an electrophoretic liquid and a plurality of colored particles distributed in the electrophoretic liquid.

18. The foldable display device of claim 1, wherein the total thickness of the driving layer, the electronic ink layer and the transparent conductive water-resisting layer is not greater than 90 micrometers.
